(19) United States
(12) Patent Application Publication
(10) Pub. No.: US 2007/0026279 A1
(43) Pub. Date: Feb. 1, 2007

(54) Vapor feed fuel cell system with controllable fuel delivery

(76) Inventors: Robert S. Hirsch, Troy, NY (US); Paul F. Mutolo, Albany, NY (US); Juan J. Becerra, Altamont, NY (US); Robert K. Sievers, Clifton Park, NY (US); J. Perry Scartozzi, Clifton Park, NY (US); William P. Acker, Rexford, NY (US)

Correspondence Address: CESARI AND MCKENNA, LLP, 88 BLACK FALCON AVENUE, BOSTON, MA, 02210, US

(21) Appl. No.: 11/542,414

(22) Filed: Oct. 3, 2006

Related U.S. Application Data
(62) Division of application No. 10/413,986, filed on Apr. 15, 2003.

(51) Int. Cl. H01M 8/04

(52) U.S. Cl. 429/22; 429/34; 429/13

(57) ABSTRACT

An adjustable fuel delivery regulation assembly is provided which can be disposed within a direct oxidation fuel cell system, or the fuel reservoir or fuel tank that supplies such a system. One embodiment of the fuel delivery regulation assembly is a shutter assembly, which includes two correspondingly perforated components. The two components can be positioned relative to one another such that the apertures in each component are aligned in certain ways. In an open position, the apertures are substantially fully aligned to permit full fuel flow. In a closed position, the apertures are offset such that there is no opening; thereby fuel flow is restricted. Intermediate positions allow adjustments in the amount of fuel flow proportional to the size of the openings. In accordance with another embodiment of the invention, a set of rotatably mounted slotted rods is inserted into a housing through which fuel can flow through openings in the housing. When the rods are rotated to a first position, the slots in the rods are aligned with the openings in the housing. When the rods are rotated to a closed position, the slots are not lined up with the openings, and fuel flow is thereby restricted. Intermediate positions allow controlled fuel delivery. A louvered assembly is also provided. Automatic and manual control systems for the adjustment of the positioning of the various components in the fuel delivery regulation assemblies are also provided.

### BACKGROUND OF THE INVENTION

1. Field of the Invention

This invention relates generally to direct oxidation fuel cells, and more particularly, to controlling fuel delivery within a fuel cell system.

2. Background Information

Fuel cells are devices in which an electrochemical reaction involving a fuel molecule is used to generate electricity. A variety of compounds may be suited for use as a fuel depending upon the specific nature of the cell. Organic compounds, such as methanol or natural gas, are attractive fuel choices due to the their high specific energy.

Fuel cell systems may be divided into “reformer-based” systems (i.e., those in which the fuel is processed in some fashion to extract hydrogen from the fuel before it is introduced into the fuel cell system) or “direct oxidation” systems in which the fuel is fed directly into the cell without the need for separate internal or external processing. Many currently developed fuel cells are reformer-based systems. However, because fuel processing is complex and generally requires components which occupy significant volume, reformer based systems are presently limited to comparatively large, high power applications.

Direct oxidation fuel cell systems may be better suited for a number of applications in smaller mobile devices (e.g., mobile phones, handheld and laptop computers), as well as in some larger scale applications. In many direct oxidation fuel cells, a carbonaceous liquid fuel (typically methanol or an aqueous methanol solution) is introduced to the anode face of a membrane electrode assembly (MEA).

One example of a direct oxidation fuel cell system is a direct methanol fuel cell system, or DMFC system. In a DMFC system, methanol or a mixture comprised of methanol and water is used as fuel (the “fuel mixture”), and oxygen, preferably from ambient air, is used as the oxidizing agent. The fundamental reactions are the anodic oxidation of the fuel mixture into CO₂, protons, and electrons; and the cathodic combination of protons, electrons and oxygen into water.

Typical DMFC systems include a fuel source, fluid and effluent management sub-systems, and air management sub-systems, in addition to the direct methanol fuel cell itself (“fuel cell”). The fuel cell typically consists of a housing, hardware for current collection and fuel and air distribution, and a membrane electrode assembly (“MEA”), which are all typically disposed within the housing.

The electricity generating reactions and the current collection in a direct oxidation fuel cell system take place within and on the MEA. In the fuel oxidation process at the anode, the products are protons, electrons and carbon dioxide. Protons (originating from fuel and water molecules involved in the anodic reaction) migrate through the catalyzed membrane electrolyte, which is impermeable to the electrons. The electrons travel through an external circuit, which includes the load, and are united with the protons and oxygen molecules in the cathodic reaction, thus providing electrical power from the fuel cell and water product at the cathode of the fuel cell.

A typical MEA includes a centrally disposed protonically-conductive, electronically non-conductive membrane (“PCM”, sometimes also referred to herein as “the catalyzed membrane”). One example of a commercially available PCM is Nafion® a registered trademark of E.I. Dupont de Nemours and Company, a cation exchange membrane based on polyperflourosulfonic acid, in a variety of thicknesses and equivalent weights. The PCM is typically coated on each face with an electrocatalyst such as platinum, or platinum/ruthenium mixtures or alloy particles. On either face of the catalyst coated PCM, the electrode assembly typically includes a diffusion layer. The diffusion layer on the anode side is employed to evenly distribute the liquid fuel mixture across the catalyzed anode face of the PCM, while allowing the gaseous product of the reaction, typically carbon dioxide, to move away from the anode face of the PCM. In the case of the cathode side, a wet-proofed diffusion layer is used to allow a sufficient supply of oxygen by minimizing or eliminating the build-up of liquid, typically water, on the cathode aspect of the PCM. Each of the anode and cathode diffusion layers also assists in the collection and conduction of electric current from the catalyzed PCM.

Direct oxidation fuel cell systems for portable electronic devices should be as small as possible at the power output required. The power output is governed by the rate of the reactions that occur at the anode and the cathode of the fuel cell. More specifically, the anode process in direct methanol fuel cells based on acidic electrolytes, including polyperflourosulfonic acid and similar polymer electrolytes, involves a reaction of one molecule of methanol with one molecule of water. In this process, the oxygen atom in the water molecule is electrochemically activated to complete the oxidation of methanol to a final CO₂ product in a six-electron process, according to the following chemical equation
CH₃OH+H₂O=CO₂+6H⁺+6e⁻ (1)

A passive fuel cell system that uses high concentration fuel without the need for external water recirculation loops has been described in commonly-assigned U.S. patent application filed of even date herewith by Ren et al. for a DIRECT OXIDATION FUEL CELL OPERATING WITH DIRECT FEED OF CONCENTRATED FUEL UNDER PASSIVE WATER MANAGEMENT [Attorney Docket No.: 107044-0026]. That application describes a passive direct oxidation fuel cell system that uses a passive mass transport barrier element disposed between the fuel source and the anode aspect of the catalyzed membrane electrolyte. In one embodiment of that invention, the passive mass transport barrier is a methanol vapor delivery film. This methanol vapor delivery film (that is sometimes referred to as an “MDF”) is a pervaporation membrane that causes the liquid methanol in the fuel tank to undergo a phase change to a vaporous fuel before it is delivered to the anode aspect of the MEA. This allows for the use of a high concentration fuel while using passive water management capabilities.

In such a passive feed fuel cell system, with passive fuel delivery (i.e. fuel is delivered without the need for a pump or other active circulation means), concentration gradients and/or water-logging at the anode can occur if the supply of fuel is from a single point, or even a single aspect of the fuel cell, absent the effect of active flow. To prevent or minimize the existence of such concentration variations along the active area of the anode of the fuel cell, fuel can be fed perpendicular to the surface of the MEA (known as “face-feeding”) to address and resolve this issue and to thus maximize the even distribution of fuel to the active anode aspect of the catalyzed membrane. In point source feeding without active fuel management, excess water can clog or interfere with point source feeding mechanisms, resulting in uneven distribution of fuel over the active portion of the MEA, causing suboptimal performance of the fuel cell system. This is especially true when the water necessary for the anodic reaction is pushed back across the catalyzed membrane.

In addition, in a vapor fed fuel cell, the fuel is typically delivered at a constant rate. However, in some instances it is desirable to change the rate of fuel delivery, or to shut down the fuel cell system. In such cases, it is advantageous to vary the fuel delivery rate in a controlled way. This can be particularly true in a vapor-fed anode using an architecture similar to that as described in the referenced co-filed U.S. patent application.

The efficiency of a direct methanol fuel cell is dependent in part upon the amount of methanol present at the anode catalyst. If more methanol is present than is needed for electricity generation, the excess will not be used for electricity generation, but instead passes through the catalyzed membrane. When excess methanol crosses over the catalyzed membrane, it reacts with oxygen in the presence of the catalyst present on the cathode side, generating heat and water. This reaction is normally not desirable as it leads to the waste of fuel. In addition, excess water may result in cathode flooding, which inhibits the introduction of oxygen to the cathode aspect of the fuel cell, thus limiting the performance of the fuel cell system. Furthermore, excess heat can result in lower performance of the fuel cell and possible deterioration of some fuel cell component structures. Accordingly, improving control of the flux of methanol that is delivered to the fuel cell system is desirable.

It may be necessary or desirable to shut the fuel cell down in other cases, such as, when a fuel cell is used as a component in a hybrid power source and the battery is fully charged, then it would be advantageous to be able to substantially completely stop the fuel feed. Thus, fuel delivery is interrupted to conserve fuel.

There are also instances in which it is desirable to allow and to temporarily encourage fuel to cross over the membrane electrolyte to generate heat. For example, when a fuel cell system is to be started or operated under cold ambient conditions, it may be desirable to deliver more methanol than is typically used to operate the fuel cell to the anode of the membrane electrolyte, allowing methanol to cross over and react on the cathode side could generate heat, which will warm the fuel cell to a normal operating point and thus allow it to start up faster. Techniques for performing a cold start of a direct oxidation fuel cell have been described in commonly-assigned U.S. patent application Ser. No. 09/798,314, filed on Mar. 2, 2001, by Acker et al., entitled COLD START AND TEMPERATURE CONTROL METHOD AND APPARATUS FOR FUEL CELL SYSTEM, which is incorporated by reference herein.

It may further be desirable to adjust the flow of fuel to the anode aspect of the MEA in response to certain environmental conditions.

Accordingly, there remains a need for an apparatus for controlling the amount of fuel that is delivered to the anode aspect of the catalyzed membrane in a passive fuel cell system. Particularly, there remains a need for regulating a vaporous fuel feed in a fuel cell system that operates with a face-fed vaporous fuel supply through a membrane placed essentially parallel to the membrane electrolyte.

It is thus an object of the invention to provide a fuel cell system that includes a device for regulating the delivery of fuel to the fuel cell, and in particular, for regulating delivery of a vaporous fuel feed to the anode of the catalyzed membrane of a direct methanol fuel cell.

### SUMMARY OF THE INVENTION

The limitations of prior techniques are overcome by the present invention, which provides a unique, direct oxidation passive fuel cell system that includes controllable fuel delivery. In accordance with the present invention, an adjustable fuel delivery regulation assembly is employed to regulate the fuel feed rate to the anode aspect of the catalyzed membrane.

The location of the adjustable fuel delivery regulation assembly in accordance with the present invention can be selected as desired in a particular application of the invention. For example, the fuel delivery regulation assembly in a first embodiment is disposed within the fuel tank or fuel cartridge such that liquid fuel contained within the tank or cartridge is controlled prior to its reaching a methanol delivery film. In a vaporous feed fuel cell system, the fuel delivery regulation assembly limits vapor generation by limiting the amount of liquid that reaches the vapor delivery film. Alternatively, the amount of vapor that is presented to the MEA or catalyzed membrane can also be regulated in accordance with the invention.

The adjustable fuel delivery regulation assembly of the present invention can be fabricated in one of a variety of alternative constructions. One aspect of the invention is embodied in a structure that includes two correspondingly perforated components that, in an open position, allow the flow of fuel through the perforations and when adjusted to a closed position, prevent flow of fuel because there are no openings through which fuel can flow. The adjustable structure also includes one or more intermediate positions in which smaller openings are provided through which a lesser amount of fuel flow is permitted in proportion to the size of the opening. These structures can be formed of slideable shutters that have apertures that are correspondingly located on each shutter component in such a manner that components can be positioned relative to one another such that the apertures can be aligned to allow fuel to flow through, or the apertures may be offset, to restrict the flow of fuel. Alternatively, the shutter components may be adjusted to an intermediate setting allowing adjustable control over the rate of fuel delivery.

In the adjustable shutter embodiment, the shutter assembly can be integrated into or mechanically attached to the fuel tank, or one of the shutter components can be integrated into or mechanically attached to the fuel tank (or fuel reservoir) and the other of the shutter components can be disposed in communication with the anode aspect of the catalyzed membrane. Alternatively, the whole shutter assembly can be placed within the fuel cell system between the fuel source and the catalyzed membrane electrolyte.

In accordance with yet another embodiment of the invention, rotateable louvers or slotted cylinders are provided which when rotated to a first position close the regulator, thus restricting fuel from flowing. When the louvers or rods are rotated to a fully opened position, full fuel flow is permitted. Intermediate positions allow control of the amount of fuel that may flow to the anode aspect, which is typically in proportion to the size of the opening provided.

In accordance with yet a further embodiment of the invention, two plates with flexible, sections supported by parallel rods for the flexible elements. The flexible elements fold up as the top plate slides in a first direction, allowing an opening for vapor transport. This allows a maximized area available for vapor flow. The spacing of the support rods can be optimized depending upon the manner of folding the flexible aspects.

In yet another embodiment of the invention, a sheet of a non-permeable elastic material material, such as Latex or Nitrile, is provided with slits that open when the sheet is stretched, or otherwise placed under tension. This embodiment provides a solution in applications that may require a thinner component due to form factor, or other constraints. In accordance with another embodiment, a porous material that is compressible by an actuator or by gas pressure can be employed to regulate vapor flow.

Variable actuation of the adjustable fuel delivery regulation assembly can be provided by any one of a number of control systems as described herein. This control provides a means for maintaining optimal efficiency of the fuel cell over a range of operating conditions. It also facilitates a successful cold-start of the fuel cell.

As noted the adjustable fuel delivery regulation assembly can be deployed within the fuel cell anode chamber, or within the associated fuel tank. In a vaporous feed fuel cell system, the vapor produced by the methanol delivery film can be limited and controlled before it reaches the anode aspect of the catalyzed membrane.

A safety fastener can be included that will be engaged when the shutter is adjusted to its closed position. In addition, a seal upon the connections can also be provided to resist any leakage of fuel from the active fuel flow areas of the fuel cell system.

### BRIEF DESCRIPTION OF THE DRAWINGS

The invention description below refers to the accompanying drawings, of which:

FIG. 1 is a simplified schematic illustration of a direct oxidation fuel cell system in which the adjustable fuel delivery regulation assembly of the present invention is located within the fuel tank or fuel reservoir to control the fuel feed prior to its reaching the methanol delivery film of the passive fuel cell system;

FIG. 2 is a simplified schematic illustration of a direct oxidation fuel cell system in which the adjustable fuel delivery regulation assembly of the present invention is located within a vapor chamber, which is contained within a passive fuel cell system;

FIG. 3A is one component of the slideable shutter assembly that has perforations to allow fuel flow therethrough;

FIG. 3B is the second component of the slideable shutter that has openings corresponding to those shown in FIG. 3A;

FIG. 4A is the slideable shutter assembly of FIGS. 3A and 3B illustrating the position in which the shutter assembly is almost fully closed;

FIG. 4B is a schematic illustration of the slideable shutter assembly of the present invention, in a substantially opened position;

FIG. 5A is a side view of one embodiment of the adjustable fuel delivery regulation assembly of the present invention, which includes rotatably mounted slotted cylinders;

FIG. 5B is an isometric front illustration of the device of FIG. 5A;

FIG. 6 is a schematic illustration of one embodiment of the adjustable fuel delivery regulation assembly of the present invention, which includes hinged louvers, which can be opened and closed to control fuel flow therethrough;

FIGS. 7A and 7B are schematic illustrations of the top and bottom plate, respectively, of another embodiment of the invention in which the top plate can be moved to allow a flexible element to fold providing an opening for fuel to flow through;

FIGS. 7C and 7D are schematic side sections of the embodiments of FIGS. 7A and 7B;

FIGS. 8A and 8B are schematic illustrations of another aspect of the invention involving a sheet that when stretched has openings that allow for the flow of vapor;

FIG. 9 is a graph which plots current in milli-amperes (mA) on the y-axis against time in minutes on the x-axis;

FIG. 10 is a plot of limiting current on the left y-axis and cell current on the right y-axis against the percent of shutter open across the x-axis, which also correlated to the total open area of the cell across the top x-axis;

FIG. 11 is a schematic illustration of another embodiment of the invention in which a compression element is employed; and

FIGS. 12A-12C illustrated further embodiments of the invention that employ expandable and compressible elements.

### DETAILED DESCRIPTION OF AN ILLUSTRATIVE EMBODIMENT

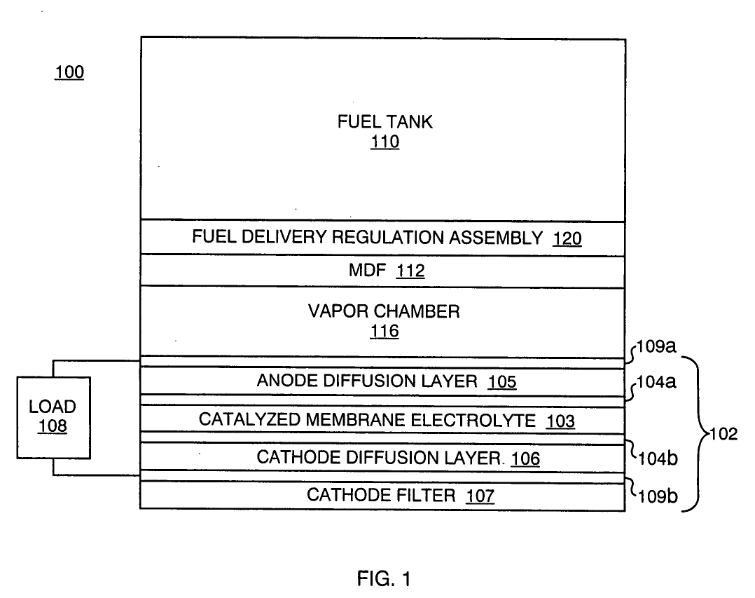

FIG. 1 illustrates a fuel cell system 100, which includes a fuel cell 102 that has a membrane electrode assembly fabricated using methods and materials known to one skilled in the art. The membrane electrode assembly includes, as discussed herein, a protonically-conductive membrane such as Nafion®. The membrane also includes a catalyst, which is in close proximity, and preferably in intimate contact with each of the major surfaces of the membrane thus forming a catalyzed membrane electrolyte 103, having a catalzyed anode aspect 104a and a catalyzed cathode aspect 104b. Diffusion layers such as an anode diffusion layer 105 and a cathode diffusion layer 107 may also be included. Current collectors 109a and 109b, comprised of an open, conductive structure, such as a metallic mesh, are used to collect and conduct electrons through load 108, which utilizes the power produced by the fuel cell as needed in a particular application. A cathode filter 107 may also be provided for the air-breathing fuel cell.

Liquid fuel is contained in the fuel tank 110. In a passive system, the fuel may be neat methanol or highly concentrated methanol. It is within the scope of the present invention that other fuels, such as ethanol and aqueous solutions or combinations of methanol and ethanol could also be employed while remaining within the scope of the present invention, provided that at least one component of the fuel is capable of passing through an MDF, as described herein.

The illustrative embodiment of the fuel cell system 100 includes a passive mass transport barrier element 112. The passive mass transport barrier element 112 is preferably a methanol delivery film (MDF) that effects a phase change on the liquid fuel coming from the fuel tank 110. It should be understood, however, that it is well within the scope of the present invention that other components and methods of providing a vaporous fuel feed to the anode of the fuel cell may be utilized, such as, for example, an atomizer vapor delivery assembly, a vaporous fuel injection system, and evaporative mechanism, and the like. The vaporous fuel provided by these or other means can be regulated by the fuel delivery regulation assembly of the present invention as described herein. In the embodiment of FIG. 1 that includes an MDF, the liquid fuel undergoes a phase change and becomes a vaporous fuel as it passes through the MDF 112 into the vapor chamber 116.

The fuel delivery regulation assembly of the present invention is shown schematically in the figures now to be described in several alternative locations relative to the other components of the fuel cell system. It should be understood that those fuel cell system components may be fabricated and assembled in a variety of different configurations. For example, the liquid fuel may be contained in a removable, replaceable and/or refillable cartridge. Such a removable cartridge may also include the methanol delivery film, MDF. Alternatively, the fuel delivery regulation assembly itself might be contained within a removable cartridge or a detachable fuel container, or may be separately detachable, as is desired based on a particular system architecture. Or, one component of the fuel delivery regulation assembly of the present invention might be contained within the cartridge, and the corresponding component may be contained within the fuel cell, or in another portion of the fuel cell system that is not in the cartridge. In other applications, the entire fuel cell system, including the components just described, may be fully contained within a singular unit or housing. A fuel cell system in any of these configurations, or combinations thereof, or other configurations are contemplated as being within the scope of the present invention.

In accordance with the present embodiment of the invention, a fuel delivery regulation assembly 120 is provided generally adjacent to the fuel tank 110. The fuel delivery regulation assembly 120 controls the delivery of fuel from the fuel tank 110 to the MDF 112. In this manner, the fuel delivery regulation assembly 120 can be used to limit vapor generation by limiting or controlling the amount of liquid fuel that travels from the fuel tank 110 to the MDF 112.

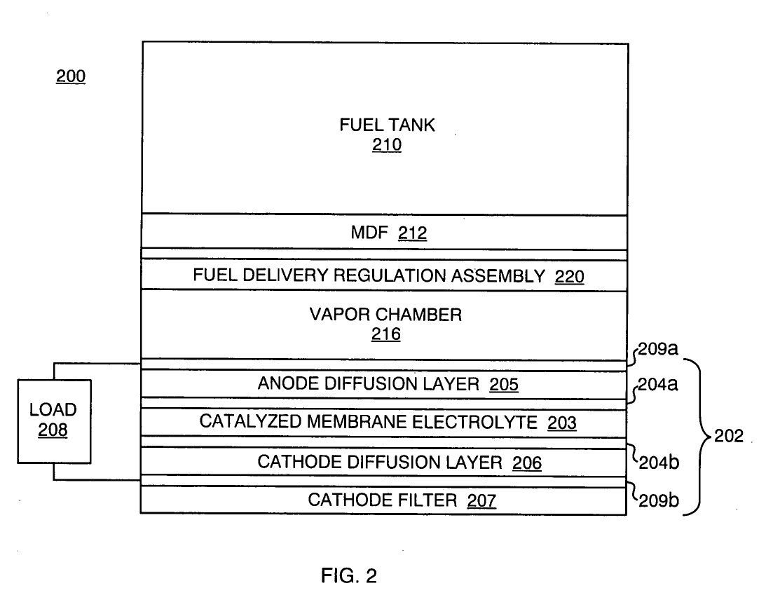

FIG. 2 illustrates another embodiment of the invention, which is a fuel cell system 200 The fuel cell system 200 of FIG. 2, as in FIG. 1, includes a methanol delivery film (or MDF) 212. The fuel cell system also includes a fuel cell 202 having a catalyzed membrane electrolyte 203, with an anode aspect 204a, and a cathode aspect 204b, to each of which a catalyst has been applied. The membrane electrolyte is disposed between an anode diffusion layer 205 and a cathode diffusion layer 206. Current collectors 209a and 209b, comprised of an open, conductive structure, such as a metallic mesh, are used to collect and conduct electrons through load 208, which utilizes the power produced by the fuel cell as needed in a particular application. A cathode filter 207 may also be provided. The methanol delivery film 212 is constructed as a pervaporation membrane, which effects a phase change when the liquid fuel, contained within the fuel tank 210, passes through the MDF 212. As noted, liquid fuel from the fuel tank 210 passes through the MDF 212 and undergoes a phase change and becomes a vapor. The vapor would then enter a vapor chamber 216 without restriction. However, in accordance with the present invention, a fuel delivery regulation assembly 220 is disposed between the MDF 212 and the MEA 203. The fuel delivery regulation assembly 220 controls the amount of vaporous fuel that travels from the vapor chamber to the anode aspect 204 of the membrane electrode assembly 203. In this embodiment, the fuel delivery regulation assembly of the present invention limits and/or controls vapor delivery to the anode aspect 204. In can be used to shut off the vaporous fuel feed in order to shut down the fuel cell system, or it can be comparatively open to allow greater amounts of fuel when needed. The location of the fuel delivery regulator can be determined depending upon the particular architecture selected for, or a particular characteristic desired for a particular application of the invention. For example, a small vapor chamber allows for faster shut off, and a large vapor chamber can accommodate a sudden need for fuel due to a larger volume of vaporous fuel within the vapor chamber. As such, the actual size of the vapor chamber will depend upon the needs of the system.

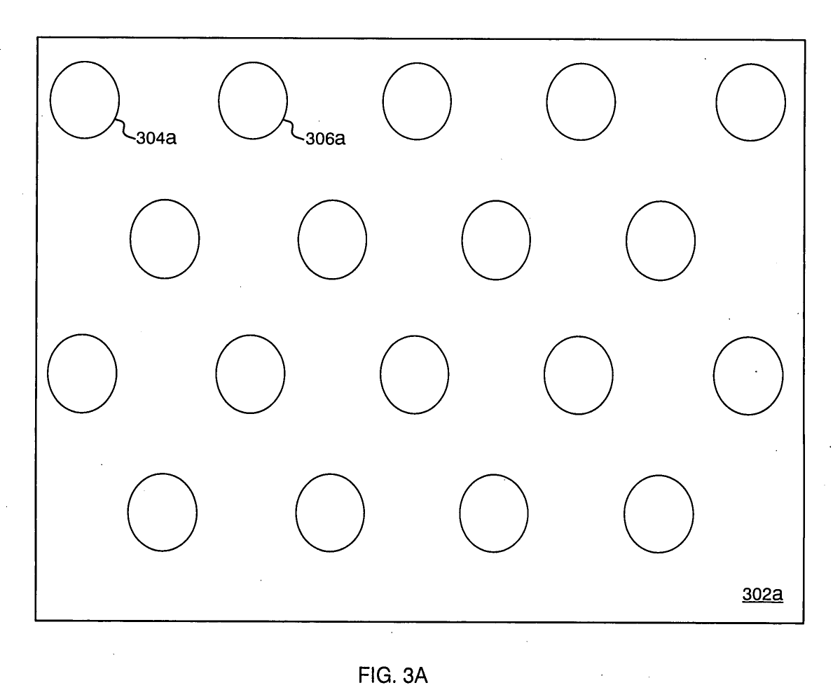

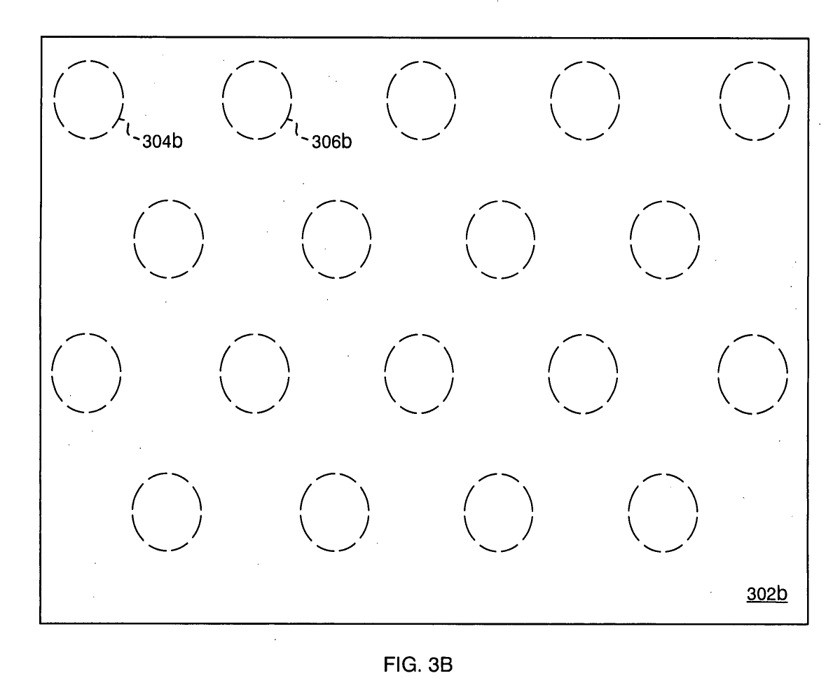

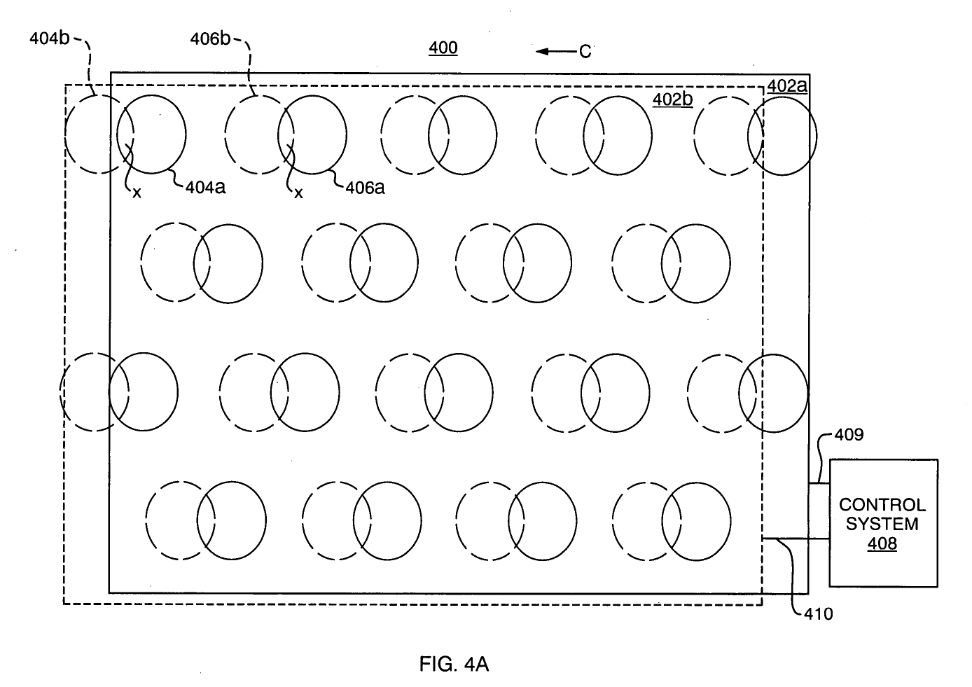

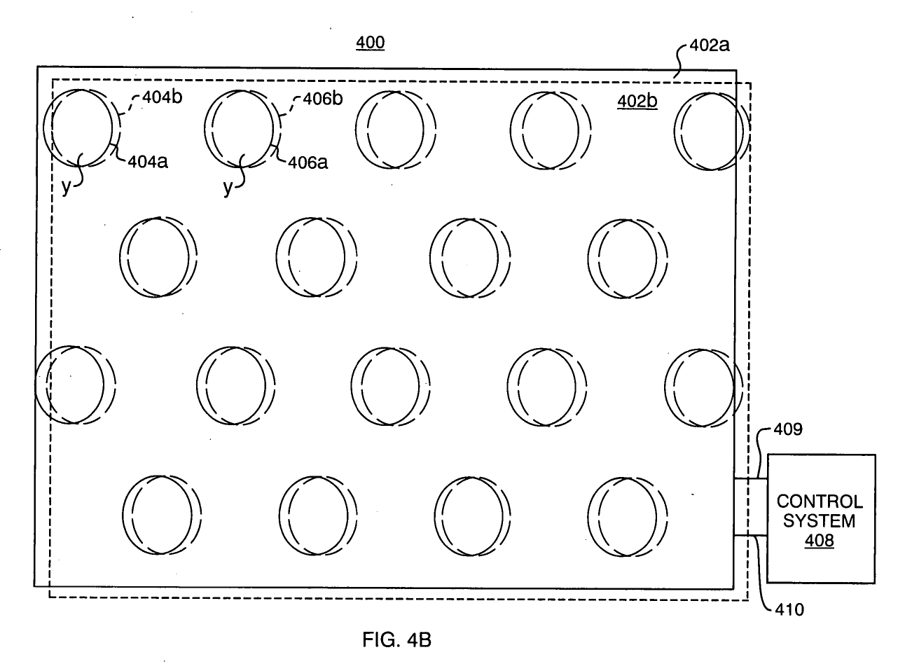

One embodiment of the fuel delivery regulation assembly of the present invention is illustrated in further detail with reference to FIGS. 3A-4B. More specifically, FIG. 3A illustrates a first component 302a of a slideable shutter assembly (FIGS. 4A and 4B). The first component 302a, includes apertures such as the apertures 304a and 306a The apertures 304a and 306a are shown as circular in FIG. 3A. However, the apertures may take any number of shapes, which may be advantageously employed depending upon the application of the invention such as, for example, without limitation, rectangular shapes such as slots and serpentine shapes, provided that they deliver fuel to the anode aspect of the MEA in a substantially uniform manner

FIG. 3B illustrates the second component 302b, which includes apertures 304b and 306b, which have a corresponding or complementary shape and location with respect to the apertures of the first component 302a. The two components 302a and 302b are slideably adjusted with respect to one another, such that the alignment of the apertures 304a and 304b, for example, define openings to permit or restrict fuel flow. The size of those openings can be controlled by the relative placement of the first component 302a with respect to second component 302b. Components 302a and 302b are fit together in such a fashion that when apertures on 304a and 304b are not aligned, they form a seal, substantially preventing vapor from being delivered to the anode aspect of the membrane electrolyte assembly.

For example, as illustrated in FIG. 4A, a combined shutter assembly 400 is illustrated. The first component 402a is in the position shown by the solid lines. The second component 402b (illustrated by dashed lines) has been adjusted in the direction of the arrow C. In the example of FIG. 4A, the apertures 404a and 406a are located with respect to the apertures illustrated by the dashed lines 404b and 406b in such a manner that the shutter assembly 400 is substantially closed. In other words, only a very small opening is left, as indicated by the letter x, to permit only a small amount of fuel flow, for example from the MDF to the vapor chamber.

By comparison, FIG. 4B illustrates the substantially open shutter assembly 400. The first component 402a is shown by the solid lines and the second component 402b is shown by the dashed lines. In this position, the apertures 404a and 406a are almost exactly lined up with the apertures shown by dashed lines, 404b and 406b. This allows maximum fuel flow through the corresponding openings designated by the letter y. Intermediate settings (not shown) could also be employed to control the delivery of fuel to a desired rate depending upon the conditions under which the fuel cell is operating.

In accordance with this embodiment of the invention, the entire shutter assembly 400 can be located within the fuel tank such as illustrated in FIG. 1. Alternatively, the shutter assembly 400 may be deployed between the MDF and the membrane electrode assembly as shown in FIG. 2. In accordance with yet a further aspect of the invention, one of the shutters, such as the first component 402a could be located within the fuel tank and the other shutter 402b could be located on the fuel cell side within the fuel cell system. It should be appreciated that the invention is readily adaptable to variations in the location of the individual components of the fuel delivery regulation assembly.

The actuation of the shutter assembly, illustrated in FIGS. 4A and 4B can be performed by a control system 408 (FIG. 4A), which includes a first means 409 for acting upon the shutter component 402a, and/or a second means 410 for acting upon the second components 402b. One or both means 409, 410 may be provided in a specific application of the invention. The control system 408 may include, for example, mechanical means, such as a wire formed from a shape memory alloy (SMA) such as a nickel-titanium (Nitinol) alloy, which will pull or push one or both of the two components 402a, 402b, relative to one another. Alternatively, a temperature sensitive bi-metal spring can act upon one or the other or both components 402a, 402b to adjust the relative positions of the two components. Temperature-controlled systems may, in turn, include a lever or spring, as noted in the control system 408. The shutter components 402a and 402b could also be physically moved manually relative to one another to achieve the desired fuel delivery control.

Alternatively, the movement of the shutter assembly components 402a and 402b may be controlled by servos acting upon one or both of the components and/or a motor could pull or push one of the components relative to the other. In addition, a gear and lever assembly could also be employed to adjust the location of the components.

The components themselves may be comprised of a polymer such as Delrin, a registered trademark of E.I. DuPont de Nemours and company, or a metal such as stainless steel, or any other suitable material that does not react substantially with methanol or other fuel or products of the reactions that occur in the fuel cell system.

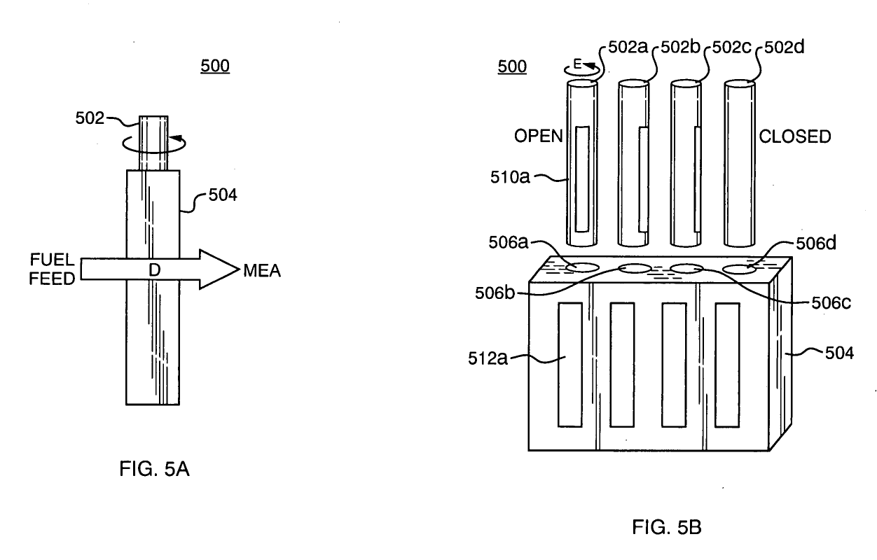

Another embodiment of the invention is illustrated in FIGS. 5A and 5B. In FIG. 5A, a fuel delivery regulation assembly 500 is shown in side view. The fuel feed is being directed to the fuel cell (not shown) in the direction of the arrow D. A rod 502 is rotatably mounted within a fuel cell delivery control housing 504. Referring now to FIG. 5B, the front view of the fuel delivery regulation assembly 500 illustrates a plurality of rods 502a, 502b, 502c and 502d that are received within openings 506a, 506b, 506c, and 506d, respectively. Each of the rods, such as the rod 502a, has an aperture or slot 510a. This aperture or slot 510a corresponds to a matching slot 612a in the fuel delivery control housing 504. When the rod 502a, for example, is rotated in the direction of the arrow E, the slot 510a will match with the corresponding slot 512a in the housing 504. A similar set of slots in contained in the opposite side of housing 504 (not visible in FIG. 5B) permit fuel to flow through the housing 504 as illustrated by the arrow D in FIG. 5A. When the slots 510a in the rods 502a match up with the slots 512a in the housing 504, the rate at which fuel passes through this assembly is maximized.

To allow a more regulated flow of fuel, the rods can be rotated substantially the same amount to an intermediate position to permit partial fuel flow. Alternatively, the rods can be adjusted independently, such that some of the rods allow more fuel to pass than other rods,

For example, the embodiment illustrated in FIGS. 5A and 5B may be used with an array of fuel cells (that are in a single plane), and the individual rods can be directed towards a particular cell in the array. Other embodiments of the invention are readily adaptable to use with a fuel cell array as well, and this is within the scope of the present invention.

The entire assembly 500, which is illustrated in FIG. 5B, may be located in any of the positions in the fuel tank or fuel cell system as illustrated in FIGS. 1 and 2. For example, the embodiment of FIG. 5B may be utilized within the fuel tank, as shown in FIG. 1, or in the fuel cell system itself, as shown in FIG. 2, as desired in a particular application of the invention.

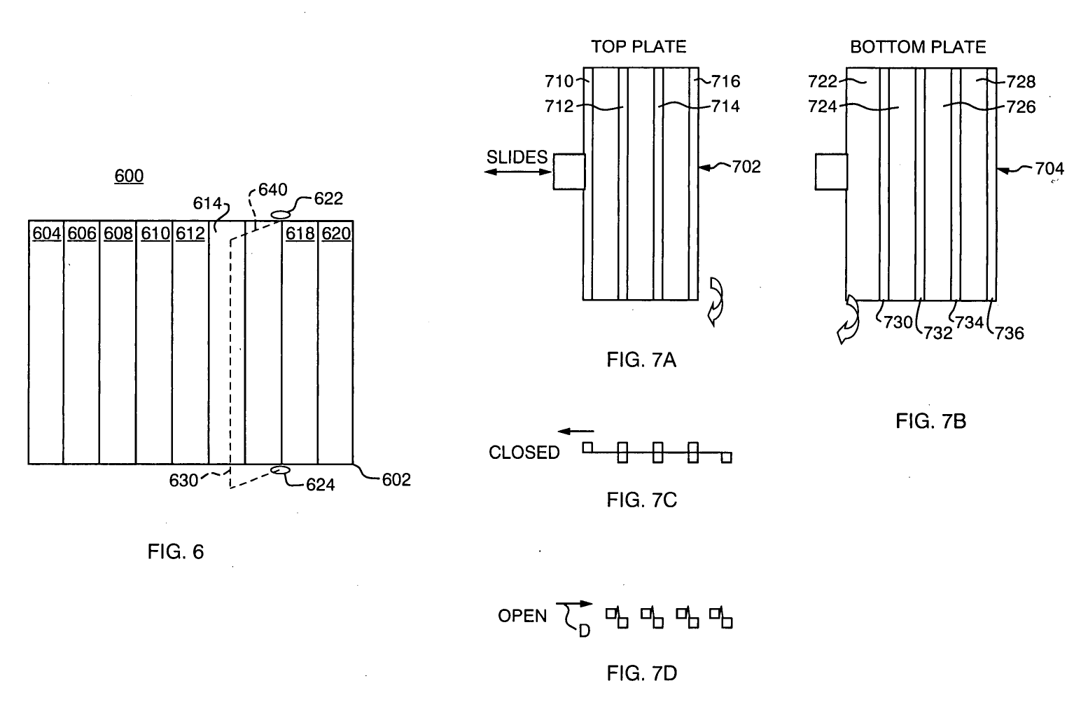

Referring now to FIG. 6, another aspect of the invention is illustrated as the fuel delivery regulation assembly 600. The fuel delivery regulation assembly 600 has a base plate structure 602 with openings 604-620. The openings 604-620 can each be fitted with a set of hinges such as the set schematically shown as 622 and 624 upon which a louver 630 is fastened. The louvers 630 can be adjusted to an open position in which case the fuel is permitted to flow through the openings, such as the opening 640, or in a closed position in which fuel is prevented from flowing. An intermediate position allows partial fuel flow such that the amount of fuel is controlled, either as it leaves the fuel tank or as it arrives at the fuel cell system.

Similar to the control system 408 described with respect to the shutter assembly 400, there are many ways in which the variable actuation of the embodiments shown in FIGS. 5A, 5B and 6, and in fact for any of the embodiments described herein, can be achieved. There are many mechanical methods of such control, including, without limitation, fastening a wire or other attachment comprised of a shape memory alloy such as a nickel-titanium (Nitinol) alloy, to at least one of the components to allow the components to adjust based on temperature. More specifically, temperature sensitive control mechanisms can allow automatic adjustment in a temperature controlled system. When the operating temperature of the fuel cell reaches a certain level, a temperature sensitive bi-metal spring for example, or temperature sensitive material will react in such a manner that the shutter assembly, for example, or the fuel delivery regulation assembly of FIG. 5A, 5B or 7 will be correspondingly adjusted automatically due to the change in temperature. Adjusting the position of the shutters manually is possible. The controls can also be regulated by an actuator whose operation is triggered based on feedback from the fuel cell system or a signal from the application device. Such feedback includes, but is not limited to, feedback that is generated in response temperature of the fuel cell, fuel cell system, or a component thereof, or which is based on the concentration of fuel that is being delivered to the anode aspect of the MEA, which can vary due to the water that is present in the vapor chamber of the fuel cell system. As noted, these variable actuation means, and combinations thereof, can be applied to the other the embodiments described herein.

Another embodiment of the invention is illustrated in FIGS. 7A through 7D. FIG. 7A illustrates a top assembly 702, which has several rods 710, 712, 714 and 716. FIG. 7B illustrates a bottom assembly 704 which has several rods 730, 732, 734 and 736. Flexible elements 722, 724, 726 and 728, which are impermeable to the flow of fuel are attached to one rod on the top assembly 702 and one rod on the bottom assembly 704. When the top plate is placed over the bottom plate, the rods are aligned as shown in FIG. 7C, stretching the flexible elements between the rods from the top assembly and bottom assembly, substantially preventing the flow of fuel from the fuel source to the anode aspect of the MEA. When the top plate 702 is moved in the direction of the arrow D as shown in FIG. 7D, the flexible sections buckle and fold up to allow for substantially free flow of vapor to the anode aspect of the MEA. This embodiment may allow for a more open flow of fuel than other embodiments, based on the pliability of flexible elements. Though shown as comprising multiple flexible elements, the invention specifically includes a system where a single flexible element is employed to regulate the flow of fuel from the fuel container to the anode aspect of the fuel cell.

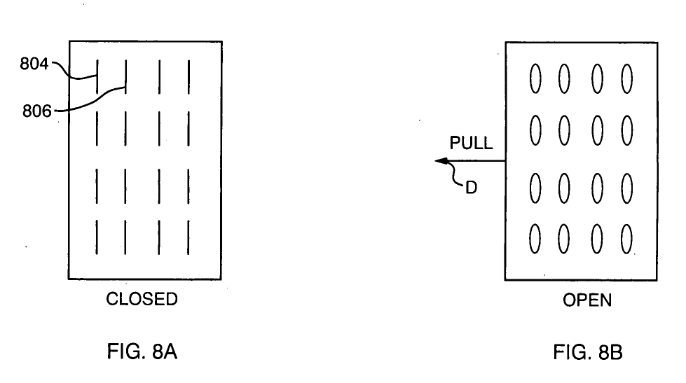

Another embodiment of the invention is illustrated in FIGS. 8A and 8B. FIG. 8A illustrates a sheet 802 of a nonpermeable elastic material such as Latex or Nitrile. Alternatively a thick sheet of silicone (at least 20-80 mils thick) could be used for this function. The sheet 802 is provided with a plurality of slit-like openings 804, 806. When the sheet is stretched, using one or more mechanical actuators (not shown) in the direction of the arrow D, the openings 804, 806 and the others shown, enlarge to form apertures through which the vaporous fuel can flow. Alternatively, actuators may be used to pull each aspect of the sheet in opposite directions, to allow for a greater open area. This embodiment provides a solution for applications that may require a thinner component due to form factor, or other constraints.

### EXAMPLE

An example of the operation of the fuel cell embodying the present invention will now be described for further illustration. An experiment was conducted to measure the variation in methanol flux (the amount of methanol delivered to the anode aspect of the fuel cell) as the shutter position is changed. The embodiment of the invention employed in the example was that illustrated in FIGS. 5A and 5B, with the rotatably mounted rods, which are also referred to in this Example as “dowels.”

A single 5 cm² DMFC was run in air-breathing mode with neat methanol vapor feed using an MDF as a mass transport layer with high methanol flux. In the test conducted, the fuel delivery regulation assembly was placed downstream of the MDF such that the shutter regulated fuel travelling from the MDF to the MEA (as illustrated in FIG. 2). The amount of MeOH reaching the MEA was controlled with the shutters. The cell current, (“J_{cell}”) at 0.3V and the limiting current (“Jₗᵢₘ”) (at 0.1-0.2V) was recorded for different positions of the shutters, as discussed below. The cell details used in the experiment were as follows: A mass transport layer MDF which was fabricated of polyurethane was disposed adjacent to the shutter face. The open area of the MDF was approximately equal to the open area of the shutters. The temperature at which the cell was run on bench top was approximately 25° C.

The physical conditions of the fuel delivery regulation assembly used in the experiment were as follows: All four shutters were actuated by hand, and manipulated as a set of four, so that they were each placed in substantially the same position as the other three during each step of the experiment. The complete arc of travel from open to closed was measured for each dowel and divided into 10 steps. Therefore, degree open is given by percent of fully open, as measured by the angle. The percent area open was determined by the area of the channel open for vapor transport. The total open area of this shutter=1.8 cm²=36% of 5 cm² MEA. As is discussed with respect to the plots, a shutter (and therefore MDF) with a greater open area (closer to 5 cm²) would allow a wider range of control over MeOH flux.

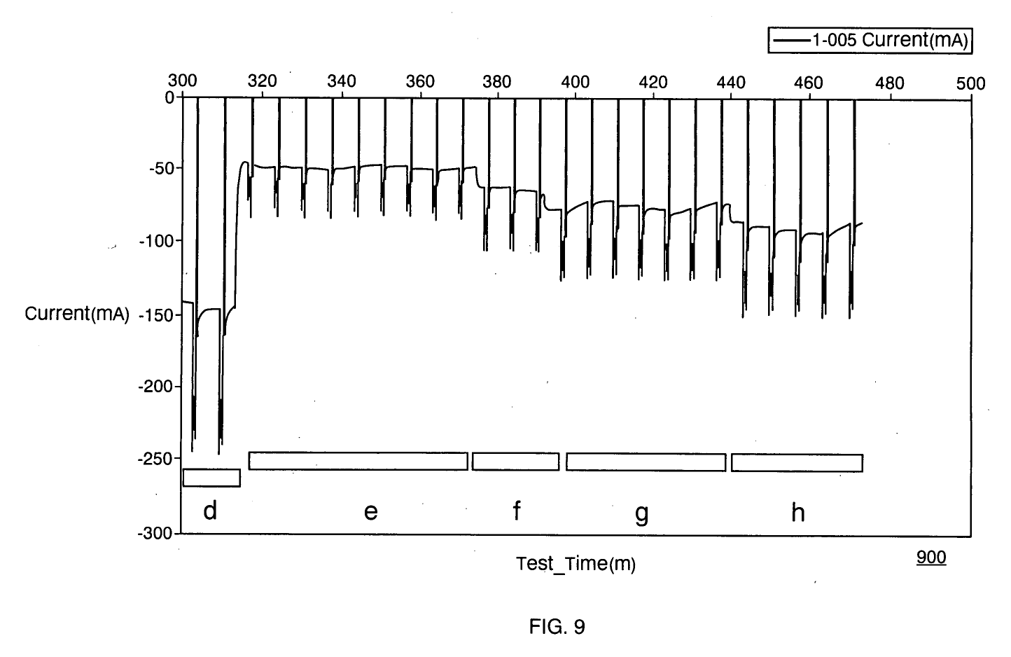

The results of the operations so conducted are illustrated in FIG. 9. FIG. 9 is a graph 900, which plots current in milliamperes (mA) on the y-axis time against time in minutes on the x-axis. The lettered bars that appear horizontally indicate the positioning of the shutters of the fuel regulation assembly. For example, the bar graph step d designates the time during which the shutters were in a substantially open position. Specifically, the shutters were set at a 60% angle. In that portion of the experiment, the current measured about 150 mA, which would correlate to a cell current J_{cell} at 3.0V of about 30 mA/cm² for a 5 cm² DMFC.

Then, the shutters were closed, as indicated by step e. As illustrated in the graph 900, the current is about 50 mA, (with a cell current of 10 mA/cm²). Then, the shutters were set to positions of successively greater degrees of opening, beginning with an opening of approximately 0.7 degrees, which is illustrated by bar f. The plot shows that the current of the slightly opened cell increased to about 65 mA (with the cell current being about 13 mA/cm²). The next step was to open the shutters to approximately 3.5-degrees as shown in step g. At this opening, the current was measured to be about 75 mA (cell current being 15 mA/cm²). And finally, as illustrated in step h, the shutters were opened to 7 degrees, which resulted in a current of about 90 mA (with a cell current of 18 mA/cm²). Accordingly, as illustrated in the graph 900, the positioning of the shutter has a significant effect on the current output of the DMFC.

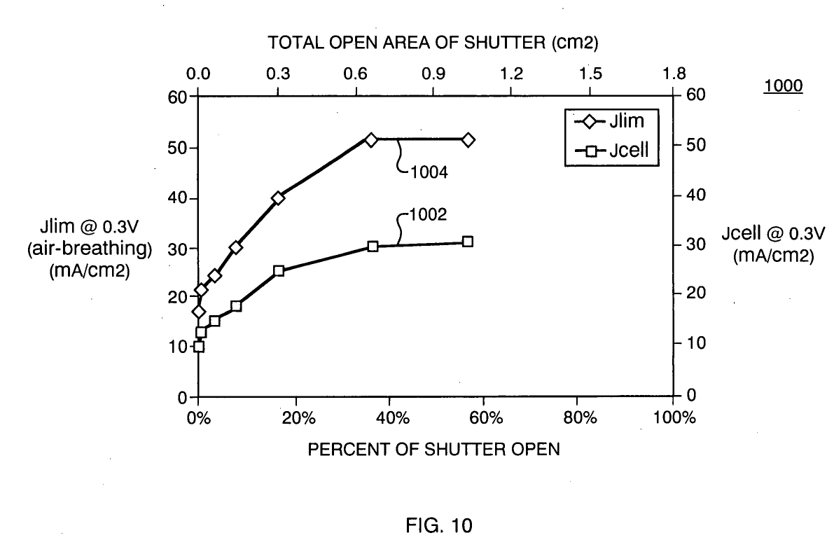

The results are also illustrated in a different format in the graph 1000 of FIG. 10. FIG. 10 is a plot of limiting current on the left y-axis and cell current on the right y-axis against the percent of shutter open across the x-axis, which also correlated to the total open area of the cell across the top x-axis. The curve 1002 with the square shaped points designates cell current. The curve 1004 with the diamond shaped points illustrates limiting current. As is apparent from the graph 1000, both the cell current (curve 1002) and limiting current (curve 1004) reach maximum values well before the shutter is opened 100%. However, the limiting current 1004 continues to be more significantly affected by the increase in shutter opening up to nearly 40% open, as compared to the cell current 1002, which begins to level off near 20%. In other words, as the shutters are opened further, methanol flux continues to increase and cause an increase in limiting current, even if cell current has leveled off. This can be important in a number of circumstances, such as for example, in the case of a cold start of the fuel cell. In the cold start, a higher methanol flux is needed for start up than would be required for example to operate the cell. Thus, the shutters can be used to provide this additional flux needed for the cold start.

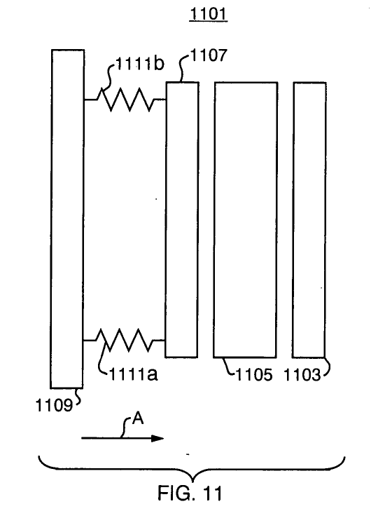

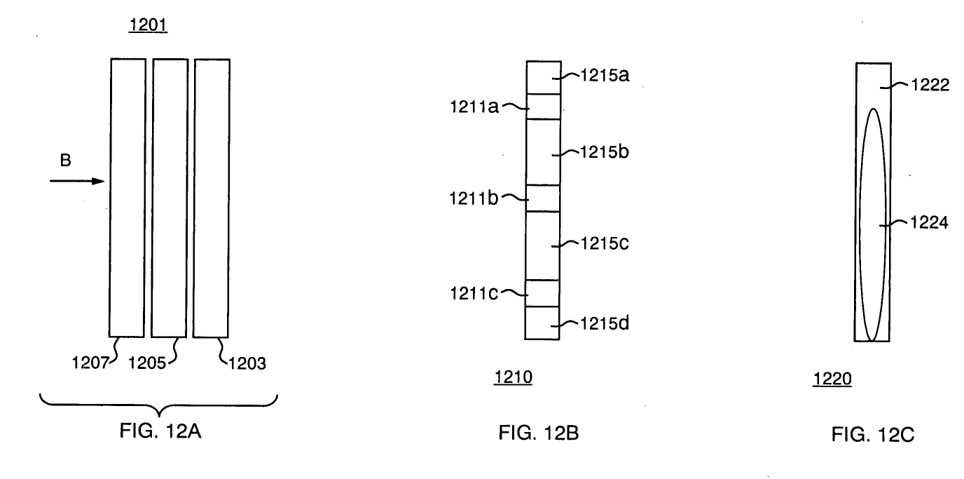

The invention also provides for vaporous fuel delivery and control using a fuel delivery regulation assembly that does not require a mechanical fuel delivery regulation assembly, but instead operates using deformable element that, when either compressed or when expanded can act to permit increased fuel flow, or to restrict vapor fuel flow. This aspect of the invention is discussed with respect to FIGS. 11 and 12A-12C.

FIG. 11 illustrates a fuel delivery regulation assembly 1101 that controls the flow of fuel to an MEA 1103. The fuel may be delivered from an associated fuel tank, fuel reservoir or fuel cartridge, (not shown in FIG. 11). The fuel preferably flows in the direction of the arrow A, although the fuel vapor may be delivered from an alternate aspect, and still fall within the invention. The fuel delivery regulation assembly 1101 includes a fuel flow control element 1105 that is a porous, compressible material. When the material of element 1105 is under compression, the porousity of the element 1105 decreases such that less vapor is delivered to MEA 1103. The fuel flow control element 1105 can be compressed by a variety of mechanisms, one of which is illustrated for example in FIG. 11. A compression element 1107 may in the illustrated embodiment be a backing plate fabricated of a rigid, but open construction that allows vaporous fuel to flow through it, while it acts to compress the fuel flow control element 1105. Pressure can be applied to compression element 1107 by force-applying components 1111a and 1111b, which are anchored by a housing or mounting plate 1109, thus causing a force to be applied to the compression element 1107, which in turn acts to compress the fuel flow control element 1105. Consequently, fuel flow control element 1105 permits less fuel to flow through to the MEA 1103.

The force-applying components 1111a, 1111b may be Nitinol springs, such as those described earlier with respect to the actuation of other embodiments of the invention. Alternatively, the components 1111a, 1111b may be mechanical actuators, temperature sensitive devices, or flexible bladders that can be filled with anodically produced carbon dioxide. The actuation means described with respect to the other embodiments of the invention, such as those that react to feedback from the fuel cell system may also be employed as the force-applying components 1111a, 1111b. The compression element 1107 itself may be a carbon dioxide bladder or other deformable material that may act directly upon the fuel control element 1105 rather than acting on a dedicated compression element. The components described may be used individually or in combination with other elements to perform the actuation of the fuel control element 1105.

Another aspect of the invention is described with reference to FIG. 12A. FIG. 12A illustrates a fuel delivery regulation assembly 1201 that controls the flow of fuel to an MEA 1203. The fuel may be delivered from an associated fuel tank, fuel reservoir or fuel cartridge, (not shown in FIG. 12A). The fuel flows generally in the direction of the arrow B. The fuel delivery regulation assembly 1201 includes a fuel flow control element 1205 that is an expandable material. When the material of element 1205 is actuated, it expands to regulate the fuel flow to MEA 1203. The fuel flow control element 1205 can be expanded by a variety of actuation mechanisms, such as temperature changes, methanol concentration changes, or a mechanical actuator.

A specific embodiment of the invention is illustrated in FIG. 12B. A fuel flow control assembly 1210 includes a series of expandable components 1211A, 1211B and 1211C. The expandable components 1211A, 1211B, 1211C may be comprised of a material that expands upon actuation. The actuation may occur, as noted, in response to temperature changes, methanol concentration changes, or other conditions within the fuel cell, and a suitable material may be selected for this purpose. Alternatively, the fuel flow control assembly may expand due to mechanical actuation. A series of second components 1215A, 1215B, 1215C and 1215D for example are interleaved between the expandable components 1211A, etc. The second set of components 1215A, etc., includes materials that deform when they are acted upon by the force of the expandable components such as 1211A, for example. For example, when the expandable components such as 1211A, 1211B and 1211C are not actuated, the second components are fully open and the assembly 1210 permits the flow of fuel through it, or permits a predetermined amount of fuel to flow through to the MEA. Then, when the expandable components 1211A, 1211B, and 1112C are actuated, they expand, pressuring the second components to deform thus the assembly restricts the fuel flow to allow a different rate of fuel flow through those components, 1215A, 1215B, 1215C and 1215D to the MEA. The entire assembly 1210 may be used as the fuel flow control element 1205 in FIG. 12A.

Another specific embodiment of the invention of FIG. 12A is illustrated in FIG. 12C. FIG. 12C illustrates a fuel flow control assembly 1220. The assembly 1220 includes a housing 1222 that includes openings that allow fuel to flow therethrough. The housing 1222 includes one or more expanded flexible bladders, such as the bladder 1224. The flexible bladder 1224 can be expanded by filling it with anodically generated carbon dioxide, for example. When the bladder 1224 expands, this in turn expands the housing 1222 to control the introduction of fuel to the MEA. The assembly 1220 may be used as the fuel flow control element 1205 in FIG. 12A. Alternatively, other methods of expansion include incorporating one or more component tubes, which expand with increased gas pressure (not shown).

It should be appreciated that the fuel delivery regulation assembly of the present invention can be used to produce a variation in the fuel flux to the anode aspect of the membrane electrode assembly. In addition, the assembly can be used to affect a variation of the DMFC cell current. Also, a low shut off current demonstrating conservation of fuel while the cell is not in operation can also be an advantageous use of the fuel delivery regulation assembly of the present invention. Fuel flow to the anode can be shut off or reduced during a power down, if for example a battery is fully recharged in a hybrid system and the fuel cell is not needed. Thus, fuel will be conserved. The present invention allows intermediate settings, which can react to temperature changes and provide the ability to cold start the fuel cell. The assembly of the present invention also has the ability to control fuel flow in an otherwise passive fuel cell system and thereby hold operation at a maximum efficiency point as desired in the particular application in which the present invention is employed.

The foregoing description has been directed to specific embodiments of the invention. It will be apparent, however, that other variations and other modifications may be made to the described embodiments, with the attainment of some or all of the advantages of such. Therefore, it is the object of the appended claims to cover all such variations and modifications as come within the true spirit and scope of the invention.

What is claimed is:

1-14. (canceled)

15. A method of controlling the delivery of a vaporous feed fuel to a direct oxidation fuel cell, including the steps of:
(A) providing an adjustable fuel delivery regulation assembly that controls either the generation of said vaporous feed from a liquid fuel, or controls said vaporous fuel feed as it travels towards said anode aspect;
(B) variably actuating a member in said adjustable fuel delivery regulation assembly to a first position when it is desired that the assembly is substantially closed to substantially restrict fuel flow; and
(C) variably actuating said member in said adjustable fuel delivery regulation assembly to a second position, which produces a plurality of openings in the assembly through which fuel is permitted to flow generally towards the anode aspect of the catalyzed membrane electrolyte, when it is desired to increase fuel flow.

16. The method of controlling the delivery of a vaporous feed fuel to a direct oxidation fuel cell as defined in claim 15, including the further step of:
providing a mass transport barrier disposed within said fuel cell to effect a change in phase from a liquid fuel to a vaporous fuel and wherein said fuel delivery regulation assembly is placed between the source of fuel and the mass transport barrier to restrict the flow of liquid fuel to said mass transport barrier, thus restricting vapor generation.

17. The method of controlling the delivery of a vaporous feed fuel to a direct oxidation fuel cell as defined in claim 15, including the further step of:
providing a mass transport barrier disposed within said fuel cell to effect a change in phase from a liquid fuel to a vaporous fuel and wherein said fuel delivery regulation assembly is placed between the mass transport barrier and the fuel cell to restrict the flow of vaporous fuel to said fuel cell.

18. A method of controlling the delivery of a vaporous fuel to a direct oxidation fuel cell, including the steps of:
(A) providing an adjustable fuel delivery regulation assembly that controls said vaporous fuel as it travels towards an anode aspect of the fuel cell; and
(B) variably actuating a member in said adjustable fuel delivery regulation assembly to regulate fuel flow to said anode aspect.
